(19) United States
(12) Patent Application Publication
(10) Pub. No.: US 2025/0028156 A1
(43) Pub. Date: Jan. 23, 2025

(54) OPTICAL ELEMENT, FRONT OPTICAL UNIT OF AN OBJECTIVE, OBJECTIVE AND MICROSCOPE

(71) Applicant: Carl Zeiss Microscopy GmbH, Jena (DE)

(72) Inventors: Renhu Shi, Göttingen (DE); Ingo Fahlbusch, Göttingen (DE); Martin Viehmann, Bovenden (DE); Sebastian Borck, Jena (DE); Yueqian Zhang, Jena (DE)

(73) Assignee: Carl Zeiss Microscopy GmbH, Jena (DE)

(21) Appl. No.: 18/772,319

(22) Filed: Jul. 15, 2024

(30) Foreign Application Priority Data
Jul. 19, 2023 (DE) 10 2023 206 847.8

(51) Int. Cl. G02B 13/18; G02B 3/00; G02B 21/02; G02B 21/33

(52) U.S. Cl. CPC G02B 13/18; G02B 3/005; G02B 3/0087; G02B 21/02; G02B 21/33; G02B 2003/0093

(57) ABSTRACT

An optical element comprises a planoconvex basic shape along an optical axis of the optical element; a third portion arranged between a first portion and a second portion. The first portion includes a plane side face for facing an object to be imaged. The second portion includes a convexly shaped side face for facing an image plane. The plane side face of the first portion is designed to collect and steer a radiation to be captured into the optical element, the optical element being designed to guide rays of the captured radiation in a beam path. The first, the second and the third portions are arranged directly adjacent to one another. A refractive index of the third portion is greater than a refractive index of the second portion, and the refractive index of the second portion is greater than a refractive index of the first portion.

### CROSS REFERENCE TO RELATED APPLICATIONS

This application claims priority to German patent application 10 2023 206 847.8 filed on Jul. 19, 2023, which is hereby incorporated by reference in its entirety.

### TECHNICAL FIELD

The disclosure relates to an optical element, optionally a front optical unit of an objective.

### BACKGROUND

System-related aberrations occur when imaging using optical systems, and these aberrations are detrimental to unfalsified imaging of an object into an image plane. One of these aberrations is known as field curvature; when it occurs, a plane object plane is not imaged into a likewise plane image plane but instead transmitted into the image plane as an “image shell.” As a rule, this case results in blurring which increases from the center ([visual] field center) to the edges of the image ([visual] field edge), and this requires continual updating of the focus. Thus, the totality of image data in an object plane of the object cannot be imaged sharply into an image plane at the same time.

Because planar detectors, for example CCD or CMOS chips, are usually used in modern optical systems, this aberration is particularly disadvantageous in this context.

The field curvature is determined to a significant extent by the properties of the utilized optical components in the beam path, and in this context particularly by the nature of the front optical unit of an objective used to capture the rays. Field curvature correction is very complicated if, moreover, the intention is to use front optical units with a high numerical aperture.

The prior art has disclosed optical elements, in particular front optical units, in which two portions with different refractive indices are combined with one another. For example, DE 10 2013 203 628 A1 describes a front lens group consisting of a plane parallel plate and a hyper-hemisphere. The two optical components are contact bonded to one another in order not to create any additional optically effective transitions and to manage without a cement or an adhesive between said components.

US 2006/0082896 A1 and US 2018/0113279 A1 relate to the reduction of the field curvature. Here, a lens in the form of a hemisphere is combined with a hyper-hemisphere in a front optical unit.

One optional object of the disclosure may be seen in proposing an improved option for reducing aberrations, optionally the field curvature.

### SUMMARY

An optical element is provided. The optical element comprises a planoconvex basic shape along an optical axis of the optical element; a first portion and a second portion, each extending around the optical axis; and a third portion arranged between the first portion and the second portion, wherein the third portion has a concave-convex form. The first portion includes a plane side face for facing an object to be imaged, and the second portion includes a convexly shaped side face for facing an image plane. The plane side face of the first portion is designed to collect and steer a radiation to be captured into the optical element, the optical element being designed to guide rays of the captured radiation in a beam path. The first, the second and the third portions are arranged directly adjacent to one another. A refractive index of the third portion is greater than a refractive index of the second portion, wherein the refractive index of the second portion is greater than a refractive index of the first portion.

An objective comprising the optical element as front optical unit is provided.

A microscope comprising the objective is provided.

### BRIEF DESCRIPTION OF THE DRAWINGS AND TABLES

Optional aspects of the disclosure will be explained in detail below. Reference is made to drawings and tables. In the FIGS.:

FIG. 1 shows, in a median longitudinal section, a schematic illustration of an optical element and also of an object to be imaged; and

FIG. 2 shows, in a median longitudinal section, a schematic illustration of a microscope having an objective, the front optical unit of which is formed by an optical element.

In the Tables:
Table 1 shows examples of dimensions of faces and portions of an objective having an optical element as front optical unit; and
Table 2 shows examples of refractive indices and field curvatures of the objective having the optical element as front optical unit.

### DESCRIPTION

The following description as well as the figures and tables are for exemplary purposes only, and are not intended to limit the scope of the disclosure in any way.

The optical element can have a planoconvex basic shape along an optical axis of the optical element. A first portion and a second portion of the optical element can be formed, each extending, optionally in rotationally symmetric fashion, around the optical axis. The portions can have refractive indices that differ from one another.

A plane side face of the first portion can face a sample space, in which an object (sample) to be imaged is arranged or can be arranged. A convexly shaped side face of the second portion faces an image space or can be made to face an image space; for instance, further optically effective elements, for example such as optical lenses, filters, stops, and/or a detector are situated in a beam path in the image space. At the plane side face of the first portion, a detection radiation to be captured can be collected and steered into the optical element and rays of the captured detection radiation can be guided in a beam path as a result of the action of the optical element.

A third portion can be present between the first portion and the second portion, wherein all three portions can be directly adjacent to one another. The refractive index of the third portion can be greater than the refractive index of the second portion, and the latter refractive index can be in turn greater than the refractive index of the first portion. Within the meaning of this description, the portions can be directly adjacent to one another if there is no space, optionally no air gap and/or liquid gap, present therebetween. By contrast, a thin layer of cement or adhesive may optionally be present between the portions.

The first portion can be planoconvex, while the third portion can have a concave-convex shape and may be in the form of a meniscus lens, for example.

Here, a meniscus or a meniscus lens can be understood to mean an optical lens whose side faces are curved in a common direction. The radii of both side faces can relate to a common virtual center.

It was found that an addition of a third portion with a refractive index that is high in relation to that of the other two portions can advantageously further reduce the arising field curvature.

The ratios of the refractive indices of the three portions can be found for example in a range between 0.7 and 0.85 for the first portion and the third portion (n1:n3) and in a range between 1.1 and 1.3 for the third and the second portion (n3:n2).

There can be different ways of producing the optical element. In an example, the first portion, the second portion and the third portion each can be components that are joined to one another along the optical axis. For example, such joining can be implemented by cementing, adhesive bonding and/or contact bonding. Such a construction can be advantageously used if the portions of the optical element consist of or comprise glass.

In another example, the first portion, the second portion and the third portion can be formed in a monolithic main body. For instance, the optical element may consist of a single body in which the three portions are affected, for example by virtue of the material in the optical element being influenced locally by means of targeted irradiation with a radiation suitable in respect of its wavelength and intensity and being altered in terms of its optical properties, optionally in terms of its respective refractive power. For instance, the material of the optical element can be a plastic which is structured for example by means of a 2-photon irradiation/2-photon method.

So that the optical element fulfils the desired function, only the plane side face of the first portion can serve to collect detection radiation. Therefore, the optical element may comprise a cover for the second and/or third portion on the side facing the sample space. For example, such a cover may be achieved by use of a coating or by use of a layer (stop) made of a light-opaque material. It is also possible for the relevant faces to be structured in order to largely or entirely prevent an ingress of light.

If the optical element is installed in an optical arrangement, for example in an objective, then an unwanted ingress of light can also be prevented by constructional measures, for example by the appropriate design of a housing for the objective and/or an optical apparatus, for example a microscope comprising the objective.

For instance, an unwanted light ingress prevention can be assisted by virtue of the plane side face of the first portion protruding beyond the third portion in the direction of the sample space. Such a construction can facilitate the coverage of the second and/or third portion by a side wall of a housing or by a cover. Moreover, this can allow the plane side face of the first portion to be brought tightly against the object to be imaged, while the other portions can be set back.

In an example, a ring-shaped cover that is not transparent to the detection radiation to be captured may be present between the portions, optionally in peripheral regions. For example, such covers along the outer radii can be designed as stops that delimit the beam path, for example in order to reduce or prevent an unwanted influence of a lens mount on a uniform passage of radiation.

The disclosure can be used—inter alia—in the field of microscopy, optionally in the field of fluorescence microscopy. The frequent requirement of a large numerical aperture in that context can be met by virtue of the second portion having a hyper-hemispherical form and the concave side face of the second portion engaging around the convexly shaped side face of the third portion at least in regions. In this case, engagement around the convexly shaped side face of the third portion can be at least to such an extent that substantially all rays from the first and the third portion propagating in the beam path are collected and guided by the second portion.

The optical element can be arranged in an optical arrangement, in particular in a detection beam path. A detection beam path can serve to capture and guide radiation coming from an object as detection radiation for imaging purposes.

The optical element can be the front optical unit of an objective, optionally an immersion objective. Such an objective can be arranged in a microscope, optionally in the detection beam path thereof. For example, such objectives can be plane apochromats and plane achromats, in which arising longitudinal chromatic aberrations are corrected. The use can be implemented with an immersion medium, for example an immersion oil. The absolute values of the resultant field curvatures can be kept below 2RE (RE=Rayleigh unit; see below). To enable the desired large apertures, the portions of an assembled optical elements have optionally emerged from what is known as ball manufacturing. In that case, optical lenses can be produced in the form of spheres or sphere portions. For example, sphere portions can be hemispheres in this case. A so-called hypo-hemisphere can be obtained if the sphere portion ends before the diameter underlying the sphere is reached. The sphere portion can also be referred to as hyper-hemisphere if the sphere portion extends beyond the diameter underlying the sphere.

Possible advantages of the disclosure lie in a significant reduction in the field curvature arising in an image plane. At the same time, the compromise to be found with regard to the correction of further aberrations, such as spherical aberration, coma, astigmatism and distortion, can be easier to find as a consequence of the disclosure. Optionally, a primary longitudinal chromatic aberration present can be fully corrected, while a longitudinal chromatic aberration of the secondary spectrum can be brought into the desired depth of focus due to the use of appropriately selected lenses.

A reduction in the field curvature can assist the use of planar detectors, improve the achievable image quality, and facilitate various applications. For example, counting specific viruses over an entire visual field can become easier and more efficient.

A further possible advantage of the disclosure can be an increase of the numerical aperture on account of the construction. For example, it was possible to show that, by use of the disclosure, an initial numerical aperture of NA=1.42 (63-times magnification) for a conventional construction of an optical assembly could be raised to NA=1.49 by means of an optional embodiment according to the disclosure of the optical element. Further examples of the disclosure can admit numerical apertures of greater than NA=1.5.

The disclosure can lead to a lens mount being required to a lesser extent, optionally when implemented in an objective. As a result, it can be possible to dispense with a component that needs very precise manufacture and adjustment. It may further be possible, that less installation space is required.

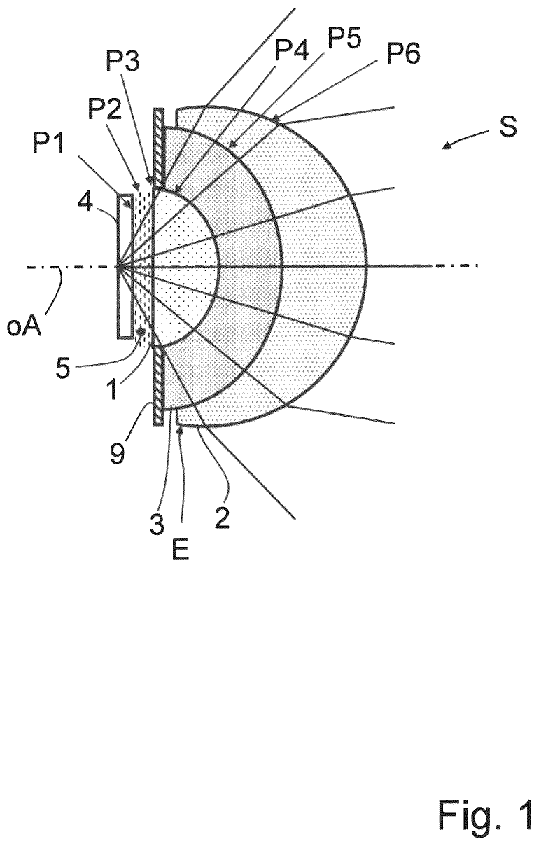

An optical element E, as depicted in FIG. 1, comprises a first portion 1 in the form of a hemisphere (planoconvex), a second portion 2 (concave-convex, hyper-hemisphere), and a third portion 3 (concave-convex; meniscus). The portions 1 to 3 are arranged directly adjacent to one another, i.e. without an air gap therebetween, along an optical axis oA of the optical element E. A joining material, for instance cement, may be present between the portions and does not abrogate a directly adjacent arrangement. The three portions 1 to 3 are formed rotationally symmetrically around the optical axis oA. Functionally, the optical element E has a planoconvex basic shape, with a plane side face of the first portion 1 facing an object 4 to be imaged and a convex side face of the second portion 2 facing away from the object 4. The refractive indices n₁, n₂ and n₃ of portions 1, 2 and 3, respectively, are related to one another as follows: n₃>n₂>n₁. The different refractive indices are elucidated by the density of the dots in portions 1, 2 and 3.

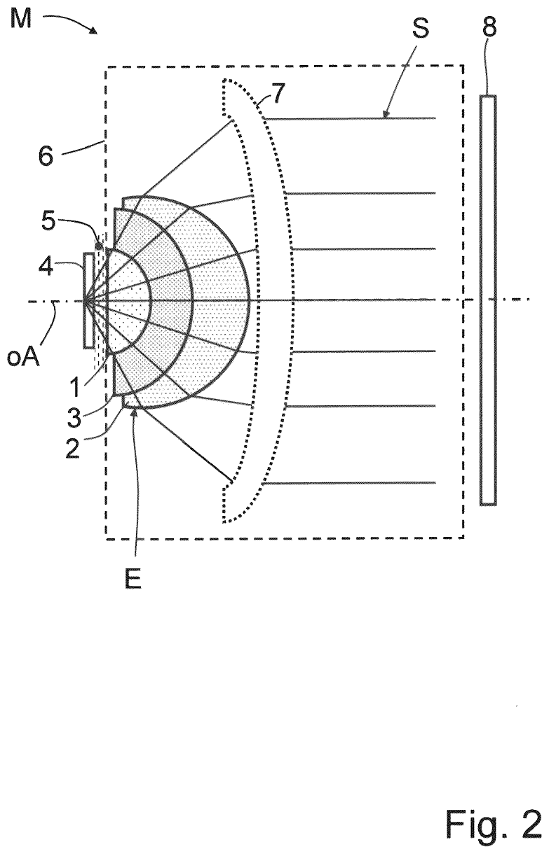

Due to the extreme ratio between a maximum path of the rays in the respective portions 1 to 3 and the radius of curvature r (see also Tables 1 and 2), all portions 1 to 3 are advantageously produced from a respective spherical lens. The face P6 facing the image plane 8 (see FIG. 2) has a hyper-hemispherical embodiment in order to meet the requirements of a high numerical aperture of the optical element E.

For simplification, here a microscope slide, for example a cover slip, a sample space containing the object 4, and a sample plane to be imaged into an image plane 8 (see FIG. 2) are together denoted by object 4. The object 4 has a thickness of for example 0.17 mm, a refractive index n (see Table 1), and a plane first face P1.

In simplified terms, FIGS. 1 and 2 show selected rays which, emanating from the object 4, are collected by means of the first portion 1 of the optical element E, steered to a beam path S, for example a detection beam path S, and guided in the latter. The plane side face of the first portion 1 protrudes slightly beyond the third portion 3 in the direction of the object 4. At the first face P1, the collected rays enter an immersion medium 5, which forms a second face P2, and from there reach into the first portion 1 with the refractive index n₁ at a third face P3. After passing through the first portion 1, the rays reach the interface to the third portion 3 (fourth face P4) and are refracted there in accordance with the refractive index n₃ of the third portion 3. The same happens following the passage through the third portion 3 at the interface to the second portion 2 at a fifth face P5. The rays leave the optical element E at a sixth face P6, where they are refracted in accordance with the refractive index n₂. The emerging rays are guided along the beam path S.

A use of an optical element E as a front optical unit in an objective 6 is shown in FIG. 2. The objective 6 is for example arranged in a detection beam path S of a microscope M, which is only indicated here. The rays emerging partly divergently from the optical element E can for example be deflected by means of a downstream optical component 7 (only indicated here) of suitable shape and refractive power and for example can be collimated therewith, with the result that said rays are guided onwards on the detection beam path S in a manner parallel to one another. Further optical components (not shown here) such as optical lenses, stops, beam splitters, filters, etc., may be present in the detection beam path S and their effect overall is that the radiation is directed for example at a detector 8 (=image plane 8) arranged in an image plane 8 and is captured thereby as image data.

One possible effect of the disclosure is explained using the example of FIGS. 1 and 2. A working distance of the front optical unit (optical element E) of an objective 6 with a large numerical aperture is determined by the thickness of the cover slip 4 and the layer thickness of the immersion medium 5 (see Table 1). The wavelength of a spectral line e chosen by way of example is 546 nm, and the numerical aperture NA in the object space is NA=1.49. The objective 6 brings about a magnification of 63. A diameter of the object field is given as 0.397 mm.

Within the scope of Seidel aberrations, a deviation of a field curvature (“image shell”) from a Gaussian image plane along the optical axis oA (z-direction) can be described by summing all face contributions. The following holds true:

$$field curvature = - 9 {15.8 [ LLW ]}^{2} \sum i [ ( {n}_{i}^{′} - {n}_{i} ) / ( {r}_{i} {n}_{i}^{′} {n}_{i} ) ] in RE ( Rayleigh unit ) , \qquad [ 1 ]$$

where:
1 RE=nλ/NA², with λ=0.000546 mm (546 nm); NA=numerical aperture;
LLW etendue=Bₘₐₓ NA, with Bₘₐₓ=maximum (object or) image height;
rᵢ is the radius (of curvature) of face i;
nᵢ is the refractive index before refraction at face i; and
nᵢ′ is the refractive index after refraction at face i.

Equation [1] can be applied both to the object space and to the image space. In the process, the image height and the numerical aperture NA should be used in the same space in each case.

Using the exemplary values from Tables 1 and 2, a field curvature=−915.8 (12.5×1.48/63)²×0.0171=−1.4 RE arises from Equation [1].

TABLE 1

| | | | Clear | | |
|---|---|---|---|---|---|
| | Radius r | Thickness | height | | |
| Face | [mm] | [mm] | [mm] | n′ | νₑ |
| P1 | plane | 0.170 | | 1.526 | 59.2 (cover slip 4) |
| P2 | plane | 0.130 | | 1.518 | 41.8 (immersion |
| | | | | | medium 5; oil) |
| P3 | plane | 1.114 | 1.250 | 1.542 | 59.4 |
| P4 | −1.6313 | 3.006 | 1.515 | 2.009 | 28.9 |
| P5 | −3.9816 | 2.955 | 3.916 | 1.635 | 63.5 |
| P6 | −4.8000 | | 4.658 | 1.000 | |

vₑ describes the Abbe number in relation to the definition wavelengths 546 nm (e), 480 nm (F′) and 644 nm (C′).

TABLE 2

| | | | | (n′ᵢ − nᵢ)/(rᵢ n′ᵢ |
|---|---|---|---|---|
| | | | | nᵢ) |
| Face | r | n | n′ | Petzval |
| P3 | plane | 1.518 | 1.542 | 0.0000 |
| P4 | −1.6313 | 1.542 | 2.009 | −0.0924 |
| P5 | −3.9816 | 2.009 | 1.635 | 0.0286 |
| P6 | −4.8000 | 1.635 | 1.000 | 0.0809 |
| | | | Sum | 0.0171 |

### LIST OF REFERENCE SYMBOLS

1 First portion
2 Second portion
3 Third portion
4 Object/microscope slide/cover slip/sample plane/sample space
5 Immersion medium
6 Objective
7 Optical component
8 Detector
9 Cover, stop
E Optical element
M Microscope
oA Optical axis
P1 First face
P2 Second face
P3 Third face
P4 Fourth face
P5 Fifth face
P6 Sixth face
S Beam path

What is claimed is:

1. An optical element comprising:
a planoconvex basic shape along an optical axis of the optical element;
a first portion and a second portion, each extending around the optical axis; and
a third portion arranged between the first portion and the second portion, wherein the third portion has a concave-convex form;
wherein the first portion includes a plane side face for facing an object to be imaged, and the second portion includes a convexly shaped side face for facing an image plane;
wherein the plane side face of the first portion is designed to collect and steer a radiation to be captured into the optical element, and the optical element is designed to guide rays of the captured radiation in a beam path;
wherein the first, the second and the third portions are arranged directly adjacent to one another; and
wherein a refractive index of the third portion is greater than a refractive index of the second portion, and wherein the refractive index of the second portion is greater than a refractive index of the first portion.

2. The optical element according to claim 1, wherein the optical element is a front optical unit of an objective.

3. The optical element according to claim 1, wherein the first portion, the second portion, and the third portion are joined to one another along the optical axis.

4. The optical element according to claim 1, wherein the first portion, the second portion and the third portion are formed in a monolithic main body.

5. The optical element according to claim 1, wherein only the plane side face of the first portion is designed to collect the radiation.

6. The optical element according to claim 5, wherein the plane side face of the first portion protrudes beyond the third portion in a direction of the object.

7. The optical element according to claim 1, wherein the second portion has a hyper-hemispherical form and engages around the convexly shaped side face of the third portion in regions.

8. An objective comprising the optical element according to claim 1 as front optical unit.

9. A microscope comprising the objective according to claim 8.
